(19) United States
(12) Patent Application Publication
(10) Pub. No.: US 2006/0236238 A1
(43) Pub. Date: Oct. 19, 2006

(54) Portable terminal and document display control method thereof

(75) Inventor: Joji Yoshikawa, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/393,500

(22) Filed: Mar. 30, 2006

(30) Foreign Application Priority Data
Mar. 30, 2005 (JP) P.2005-098520

(51) Int. Cl. G06F 17/00

(52) U.S. Cl. 715/530

(57) ABSTRACT

A portable terminal includes a display section for displaying a document, and a control section for performing a control. The control includes: dividing an entire display region or a partial display region of the display section into a first display region and a second display region; displaying a document which is generated under such an assumption that the document is not intended to be displayed on the display section on the first display region; extracting a character string from apart of the document displayed on the first display region; and displaying the extracted character string on the second display region.

This application claims foreign priority based on Japanese Patent application No. 2005-098520, filed Mar. 30, 2005, the contents of which is incorporated herein by reference in its entirety.

### BACKGROUND OF THE INVENTION

1. Field of the Invention

The present invention is related to a portable terminal and a document display control method thereof, by which either an entire display region or a partial display region of a display section is divided into a first display region and a second display region, a document is displayed on the first display region, and apart of the document displayed on the first display region is displayed on the second display region.

2. Description of the Related Art

There are many cases in which the following assumptions are made with respect to a document which is generated by a software operable in a personal computer and the like, such as a word processor software and a spreadsheet software. That is, when the document is displayed on a screen of a CRT display and the like, dot numbers of a display region in a lateral direction and a longitudinal direction are designed to be, for example, 640*480 dots, or the document is displayed on the screen in the same ratio as to the above dot numbers.

In contrast, in a related portable terminal such as a portable telephone and a PDA (Personal Digital Assistant), a display screen of a display section thereof is made compact. Furthermore, a ratio (aspect ratio) of dot numbers of the display screen in a lateral direction and a longitudinal direction is different from the above aspect ratio of the screen used in the personal computer and the like.

As a result, in the related portable terminal, such a document generated by the personal computer cannot be displayed within the display screen of the display section while easily readable sizes of this document are maintained. In other words, this document is generated under an assumption that this document is intended to be displayed on a display screen larger than the display screen of the display section employed in the related portable terminal, or is intended to be displayed on a display screen having a different aspect ratio from that of the related portable terminal, and so on.

As a consequence, in the related portable terminal, the following requests are made so that the document which cannot be fitted within the display screen of the display section due to the difference in the aspect ratio and the difference in the screen size may be used. That is, a character string or the like of a sentence contained in this document is enlarged so as to be easily read, and at the same time, a user can understand that such an enlarged character string or the like is located at which position in the entire document.

On the other hand, in order to satisfy a similar request to that of the above-explained related portable terminal such that the character string or the like of the sentence contained in this document is enlarged so as to be easily read, and at the same time, the user can understand that such an enlarged character string or the like is located at which position in the entire document, document processing apparatus (word processor) has been proposed (refer to JP-A-7-21157). In the document processing apparatus, although not shown in the drawing, while a display region of the display screen is divided into two display regions, such as a first display region and a second display region, the entire document is displayed on the first display region in a reduced size, and further, a part of the document displayed on the first display region is displayed on the second display region in an enlarged size.

In accordance with the document processing apparatus, the character string or the like contained in the document displayed on the first display region is enlarged on the second display region to be easily read. At the same time, the user can understand that such an enlarged character string is located at which place in the entire document based upon the display of the entire document of the first display region.

However, since the document processing apparatus described in JP-A-7-21157 has a display screen of which size being larger than a certain screen size, even when a part of the document displayed on the first display region of this display screen is displayed in the enlarge size on the second display region, a drawback caused by the enlarging display is not conspicuously appeared. However, in a case where the above-explained technique in JP-A-7-21157 is applied to the related portable terminal, since the display screen of the display section is smaller than that of the above-described document processing apparatus, the drawback caused by the enlarging display may conspicuously appear. Therefore, actually, the technique in JP-A-7-21157 cannot be applied to the related portable terminal.

In other words, when the document generated by the personal computer or the like is displayed on the related portable terminal, by applying the technique in JP-A-7-21157 to this related portable terminal, the display screen is divided into the first display region and the second display region, the entire document is displayed on the first display region in the reduced size, whereas the part of the document displayed on the first display region is displayed on the second display region in the enlarged size. Then, the below-mentioned drawbacks appear. That is, since the part is simply enlarged, when sizes of the characters which are displayed on the second display region in the enlarged size are simply enlarged up to a character size that is large enough for the user to recognize the characters, a total number of characters which can be displayed in one line of the second display region is reduced, as compared with that of the first display region. As a result, an entire part of a character string from a head to an end in each line of the document cannot be fitted in the second display region.

As a result, when the technique of JP-A-7-21157 is merely applied to the related portable terminal, there is such a problem that troublesome operations need to be performed while the user continues on reading the sentences which are displayed in the enlarge size on the second display region of the display section employed in the related portable terminal. That is, the user needs to perform scrolling operations frequently for scrolling the character string displayed on the second display region from the head side to the end side for every line, and also, scrolling the character string from an end of the preceding line to a head of the succeeding line for return. In other words, when the character string displayed on the second display region is read, such a scrolling operation in which a reading operation goes and returns between the head side and the end side in each of the lines is troublesome.

### SUMMARY OF THE INVENTION

An object of the present invention is to provide a portable terminal and a document display control method of the portable terminal, in which while either an entire display region or a partial display region of a display section is divided into a first display region and a second display region, a document which is generated under such an assumption that the document is not intended to be displayed on the display section is displayed on the first display region, and a part of the document displayed on this first display region is displayed on the second display region. In order to read a character string to be displayed on the second display region, the portable terminal need not perform such a scrolling operation in which a reading operation goes and returns between a head side and an end side in each line of the character string to be displayed on the second display region.

In some implementations, a portable terminal of the invention comprises: a display section; and a control section for dividing at least a part of a display region of the display section into a first display region and a second display region, making the display section to display a document on the first display region, extracting a character string from the document displayed on the first display region, and making the display section to display the extracted character string on the second display region.

In the portable terminal of the invention, the control section makes the display section to display the character string on the second display region in a different font from that of the document displayed on the first display region.

In the portable terminal of the invention, the control section makes the display section to display an extracted part of the document on the first display region in a different mode from that of other part of the document, the extracted part of the document corresponding to the extracted character string or the character string to be extracted.

In the portable terminal of the invention, in a case where an operation for displaying a subsequent character on the second display region is performed, the subsequent character being subsequent to the displayed character string on the second display region, the control section performs: deleting a first character of a head of the character string; sequentially moving up a display position of respective characters which follow after the first character so as to move up the character string; extracting the subsequent character that is subsequent to an extracted part of the document corresponding to the character string being displayed on the second display region; and adding the extracted character to an end of the moved-up character string so as to be displayed on the second display region.

In the portable terminal of the invention, the second display region displays the character string in a plurality of lines by inserting a line feed in the character string for every predetermined number of characters, and in a case where an operation for displaying a subsequent line on the second display region is performed, the subsequent line being subsequent to a final line of the character string displayed on the second display region, the control section performs: deleting a first line at a head line of the character string; sequentially moving up a display position of respective lines of the character string which follow after the first line so as to move up the character string; extracting the predetermined number of characters as the subsequent line which is subsequent to an extracted part of the document corresponding to the character string being displayed on the second display region; and adding the extracted characters as a new line to the final line of the moved-up character string so as to be displayed on the second display region.

In the portable terminal of the invention, in a case where an operation for switching display regions is performed, the control section performs switching the first display region and the second display region.

In some implementations, a document display control method of the invention used in a portable terminal having a display section comprises: dividing at least apart of a display region of the display section into a first display region and a second display region; displaying a document on the first display region; extracting a character string from the document displayed on the first display region; and displaying the extracted character string on the second display region.

According to the portable terminal and the document display control method thereof, either the entire display region or the partial display region of the display section is divided into the first display region and the second display region, the document which is generated under such an assumption that the document is not intended to be displayed on the display section is displayed on the first display region, and a part of the document displayed on this first display region is displayed on the second display region. Accordingly, scrolling operations in which a reading operation goes and returns between the head side of each line of a character string and the end side thereof can be reduced in order to read the character string to be displayed on the second display region.

### BRIEF DESCRIPTION OF THE DRAWINGS

FIG. 1 is a block diagram showing a circuit configuration of a portable telephone 2 according to an embodiment of the invention.

FIG. 2 is a plan view showing the portable telephone 2 according to an embodiment of the present invention.

FIG. 3 is a plan view showing a state in which a document 40 is displayed integrally in both a document display area 22 and a sentence display area 24 of a display screen 18 shown in FIG. 2.

FIG. 4 is a diagram showing a state in which the document 40 is displayed on the document display area 22 and a character string of a part of the document 40 is displayed on the sentence display area 24 of the display screen 18 shown in FIG. 2, that is, a plan view showing a state in which the document 40 in the document display area 22 is displayed before being reduced.

FIG. 5 is a diagram showing a state in which the document 40 is displayed on the document display area 22 and a character string of a part of the document 40 is displayed on the sentence display area 24 of the display screen 18 shown in FIG. 2, that is, a plan view showing a state in which the document 40 in the document display area 22 is displayed after being reduced.

FIG. 6 is a flow chart showing operation sequences of a control section 16 executed in correspondence with an operation after a document display mode is initiated.

FIG. 7 is a flow chart showing operation sequences of the control section 16 executed in correspondence with an operation after the document display mode is initiated.

FIG. 8 is a flow chart showing operation sequences of the control section 16 executed in correspondence with an operation after the document display mode is initiated.

FIG. 9 is a flow chart showing operation sequences of the control section 16 executed in correspondence with an operation after the document display mode is initiated.

FIG. 10 shows a table of keys in an operation section 6, which are used in various operations in the sentence display mode.

FIG. 11 is a diagram showing a state in which the document 40 is displayed in a reduced size on the document display area 22 of the display screen 18, and a character string of a part of the document 40 is displayed on the sentence display area 24 of the display screen 18 shown in FIG. 2, that is, a plan view showing that the character string of the sentence display area 24 is moved up by one line in an up direction.

FIG. 12 is a flow chart showing operation sequences of the control section 16 executed in correspondence with an operation after the sentence display mode is initiated, that is, a subroutine of a step S111 shown in FIG. 7.

FIG. 13 is a diagram showing a state in which the document 40 is displayed on the document display area 22 when a section mode is ON, and a character string of a part of the document 40 is displayed on the sentence display area 24 of the display screen 18 shown in FIG. 2, that is, a plan view showing a state before a frame 42 of a document display area 22 is moved.

FIG. 14 is a diagram showing a state in which the document 40 is displayed on the document display area 22 when the section mode is ON, and a character string of a part of the document 40 is displayed on the sentence display area 24 of the display screen 18 shown in FIG. 2, that is, a plan view showing a state after the frame 42 of the document display area 22 is moved.

FIG. 15 is a structural diagram showing a document 50 which is displayed on the document display area 22 of the display screen 18 shown in FIG. 2.

FIG. 16 is a flow chart showing operation sequences of the control section 16 executed when connection data 52 as to the document 50 is generated or the like.

FIG. 17 is a flow chart showing operation sequences of the control section 16 executed when the connection data 52 as to the document 50 is generated, that is, a subroutine of a step S304 shown in FIG. 16.

### DESCRIPTION OF THE PREFERRED EMBODIMENTS

Next, a concrete description is made on embodiments of a portable terminal and a document display control method thereof according to the present invention with reference to drawings.

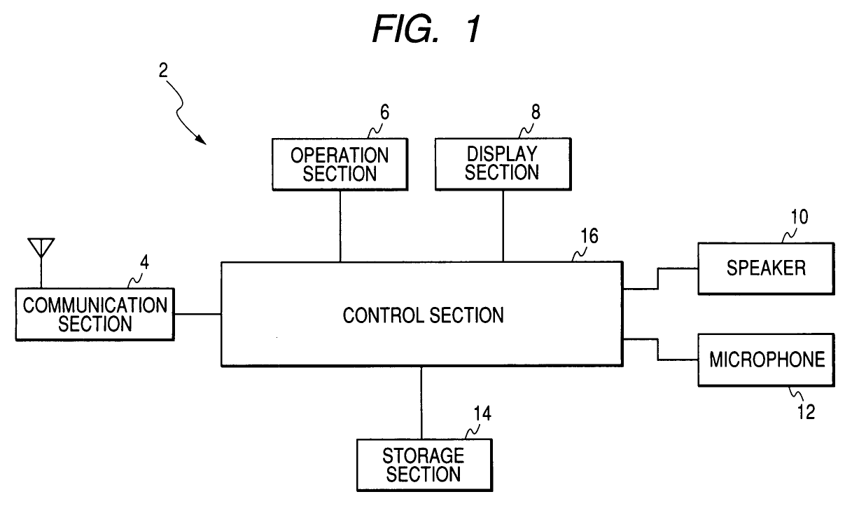

FIGS. 1 to 17 are diagrams for explaining a portable telephone 2 (portable terminal) and a document display control method thereof according to an embodiment of the present invention.

FIG. 1 is a block diagram for schematically showing a circuit arrangement of the portable telephone 2 according to the present embodiment. As shown in this drawing, the portable telephone 2 is provided with a communication section 4, an operation section 6, a display section 8, a speaker 10, a microphone 12, a storage section 14, and a control section 16 which controls these sections.

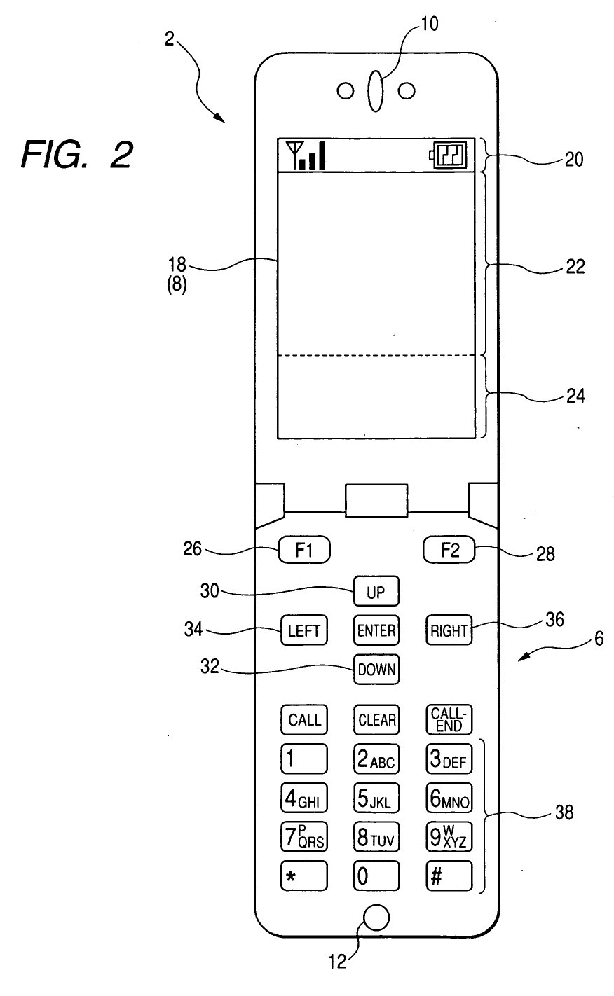

As shown in FIG. 2, as to the display section 8 of the portable telephone 2, a display region of a display screen 18 of this display section 8 is divided into a pictorial area 20, a document display area 22 (first display region) and a sentence display area 24 (second display region) in this order from a side of the speaker 10.

During a normal operation of the portable telephone 2, both the document display area 22 and the sentence display area 24 integrally display thereon an image and the like. When a display mode is switched to a sentence display mode (will be explained later), the document display area 22 displays thereon a document which is designated by a user, whereas the sentence display area 24 displays thereon a character string of a part contained in the document displayed on the document display area 22. These displays are realized by the control section 16 controlling a driver in the display section 8.

Also, the operation section 6 includes a first function key 26, a second function key 28, an up direction key 30, a down direction key 32, a left direction key 34, a right direction key 36 and ten-numeral keys 38. In this ten-numeral keys 38, not only numeral keys “1” to “9” and “0”, but also a key “*” and a key “#” are provided.

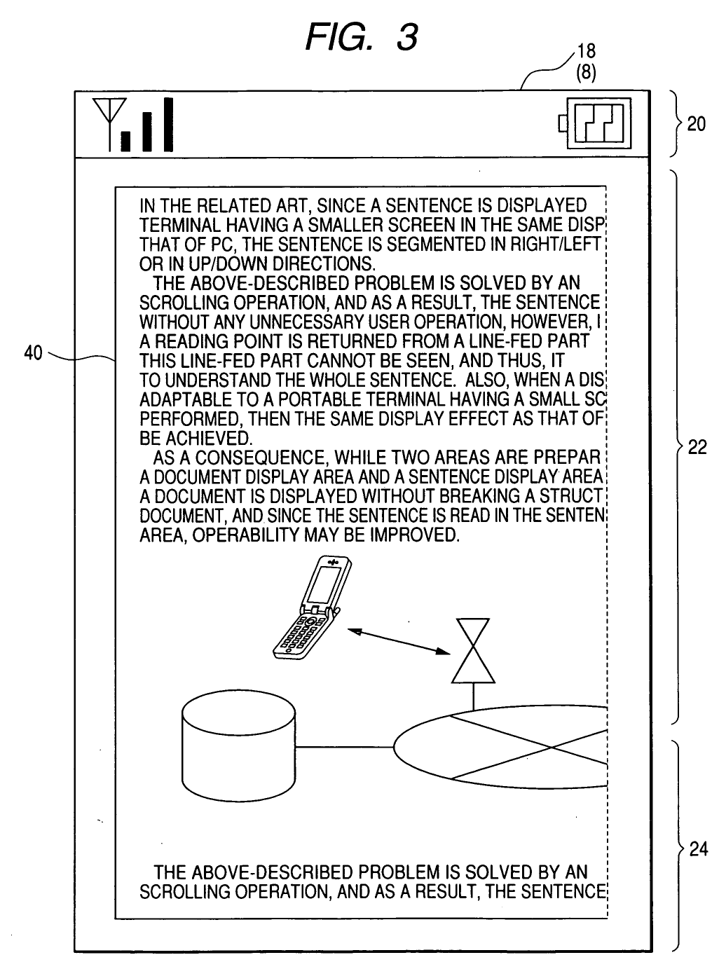

Next, process operations of the control section 16 with respect to the display section 8 will now be explained. When an operation for displaying a document on the display screen 18 of the display section 8 is performed in a normal mode of the portable telephone 2, the control section 16 displays the document designated by this operation in both the document display area 22 and the sentence display area 24 integrally (refer to FIG. 3).

The user can designate a document which can be acquired from a server on a communication line network (not shown) via the communication section 4 shown in FIG. 1, and a document stored in the storage section 14, as a document which may be displayed on the display screen 18 by way of an operation.

The portable telephone 2 can display the following document on the display screen 18 by the above operation of designating the document. That is, not only a document which is generated under such an assumption that this document is intended to be displayed on the display section 8 of this portable telephone 2 or the like from the beginning, but also a document which is generated so as to be displayed by a personal computer can be displayed. In other words, the document generated for the personal computer is generated in such an assumption that this document is displayed on a screen larger than the display screen 18 of the display section 8 of the portable telephone 2, or displayed on a screen whose aspect ratio is different from that of the display screen 18 of the display section 8.

The above technique is called as a “document viewer.” For example, in a case where there is a document generated for the personal computer and the document is going to be displayed on the display section 8 of the portable telephone 2, the “document viewer” converts this document into a document directed to the portable telephone 2 in accordance with the below-mentioned sequential operations.

Firstly, character strings (text) described in the document directed to the personal computer, a display mode thereof (display color, font type, font size), display coordinates (not only coordinates, but also a format of a positional relation among extracted characteristics may be employed), and furthermore, an image to be inserted and display coordinates of this image are extracted from the document directed to the personal computer (namely, Web page on the Internet, document generated by a word processor software or a spreadsheet software), by executing a routine similar to a software for printing the document on a printer.

Next, based on the extracted information, an arrangement change (especially, as to coordinates) is performed on the document directed to the personal computer which is a laterally long document, so that the document is rearranged to a longitudinally long document to a maximum extent (because display section 8 of portable telephone 2 is longitudinally long). The rearranged document is once stored in the storage section 14, and then, the control section 16 instructs the driver of the display section 8 to display the stored document based on the stored arrangement. However, even when such an arrangement change is performed, it is practically difficult to display the rearranged document completely on the display section 8.

In a case where the below-mentioned document is designated as a document to be displayed on the display screen 18 by an initiating operation of the document viewer, this document is displayed under such a condition that an entire part thereof cannot be fitted in the display screen 18. That is, this document is generated under such an assumption that the document is displayed on a screen larger than the display screen 18 of the display section 8 of the portable telephone 2, or on another screen whose aspect ratio is different from that of the display screen 18.

For example, as shown in FIG. 3, in the beginning, a document 40 displayed on the display screen 18 is not generated under such an assumption that this document 40 is intended to be displayed on the display screen 18 of the portable telephone 2, or the like, but is generated under such an assumption that this document 40 is intended to be displayed on another different type of screen from the display screen 18, namely, a size and an aspect ratio of this screen are different from those of the display screen 18. As a result, a right side part of the document 40 is cut off, and as to sentences contained in this document 40, end sides of respective lines of these sentences are not displayed.

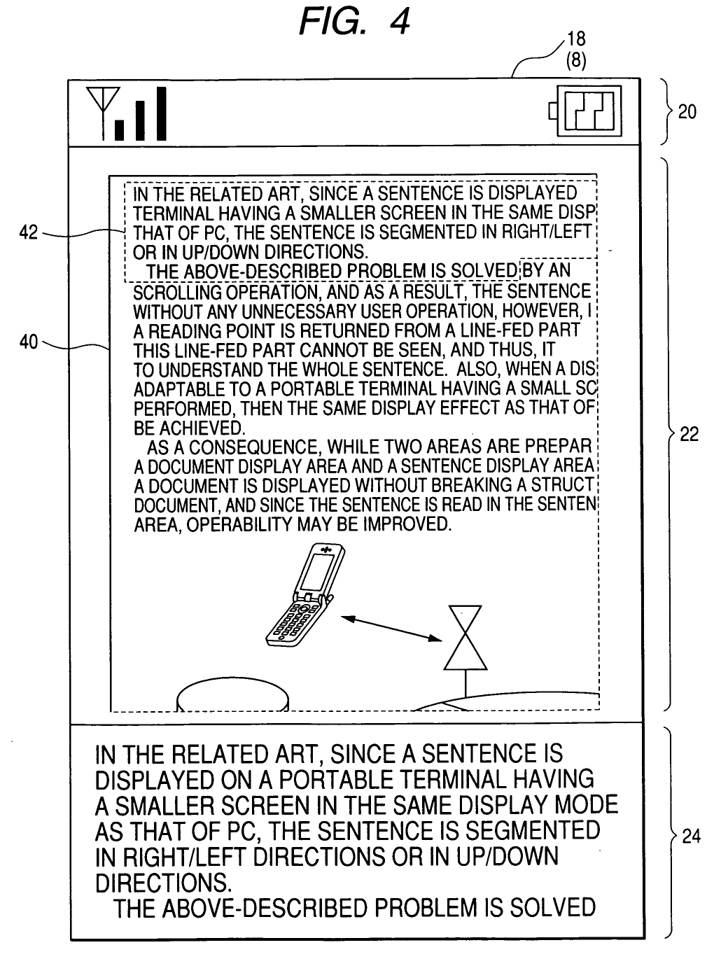

Under this condition, when a predetermined operation for switching the display mode to the sentence display mode is performed with respect to the portable telephone 2, as shown in FIG. 4, the control section 16 displays the document 40 and a frame 42 (focus) of a dotted line only on the document display area 22. The frame 42 surrounds a character string of a continuing part of a sentence contained in this document 40.

The frame 42 surrounds the character string in a continuing range, including the character string on the end sides of respective lines in the sentences of the document 40, which are not displayed within the document display area 22. Then, the control section 16 displays the character string of the sentences in the document 40, which are surrounded by the frame 42, on the sentence display area 24 so as to be displayed in a different character size from the original character size as shown in the document display area 22, and so as to be inserted a line feed within the sentence display area 24.

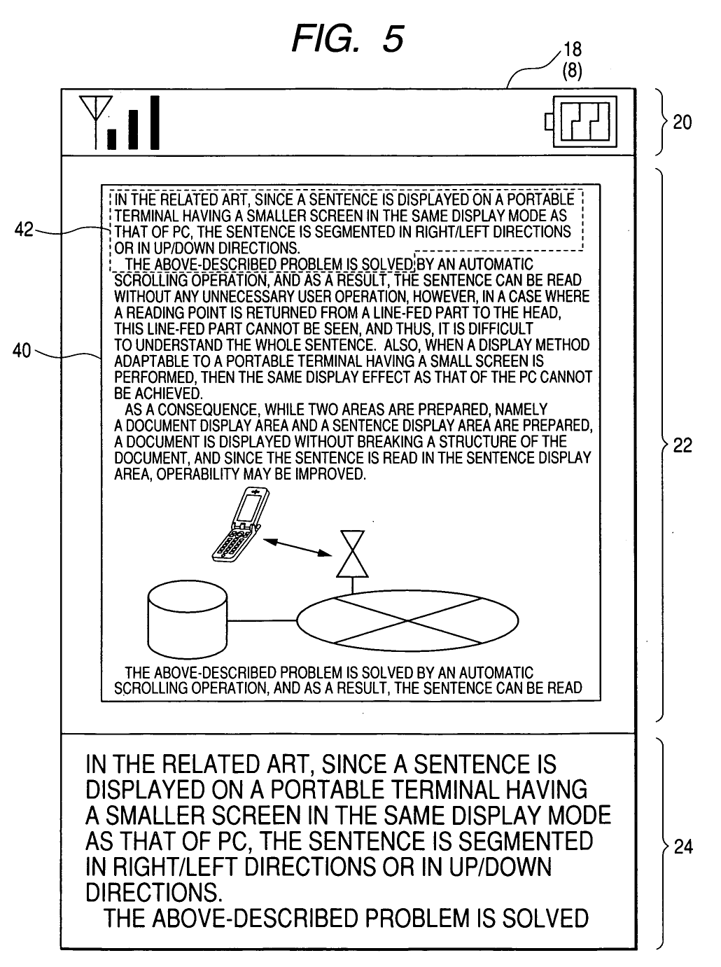

Since the sentence parts of the end sides for the respective lines, which are not displayed within the document display area 22, are included in the character string of a document part in the sentences in the document 40, which are surrounded by the frame 42, the user cannot confirm the entire range of the character string surrounded by the frame 42 in the state that the document 40 is initially displayed. However, when a reduction display operation (will be explained later) of the document display area 22 is performed, as shown in FIG. 5, the document 40 within the document display area 22 is displayed in the reduced size, so that the user can confirm the entire range of the character string surrounded by the frame 42.

Also, when the character string in the document 40, which are surrounded by the frame 42, is displayed on the sentence display area 24, the control section 16 reads a character code such as JIS (Japan Industrial Standard) code for each of the characters in the document 40. Then, the control section 16 displays a character which corresponds to the read character code on the sentence display area 24. As a consequence, the character string can be displayed on the sentence display area 24 in another font which is different from the font used in the document 40.

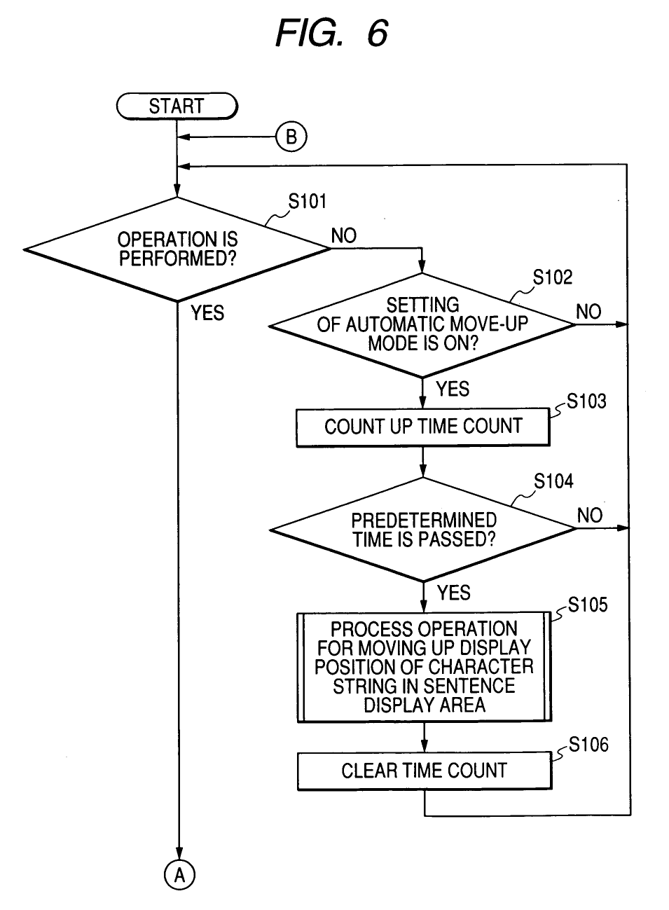

Next, referring to flow charts shown in FIG. 6 through FIG. 9, a description is made on process operations of the control section 16 corresponding to operations which are performed after the sentence display mode is initiated. In the sentence display mode, the sentence display area 24 displays the character string of the document part of the document 40.

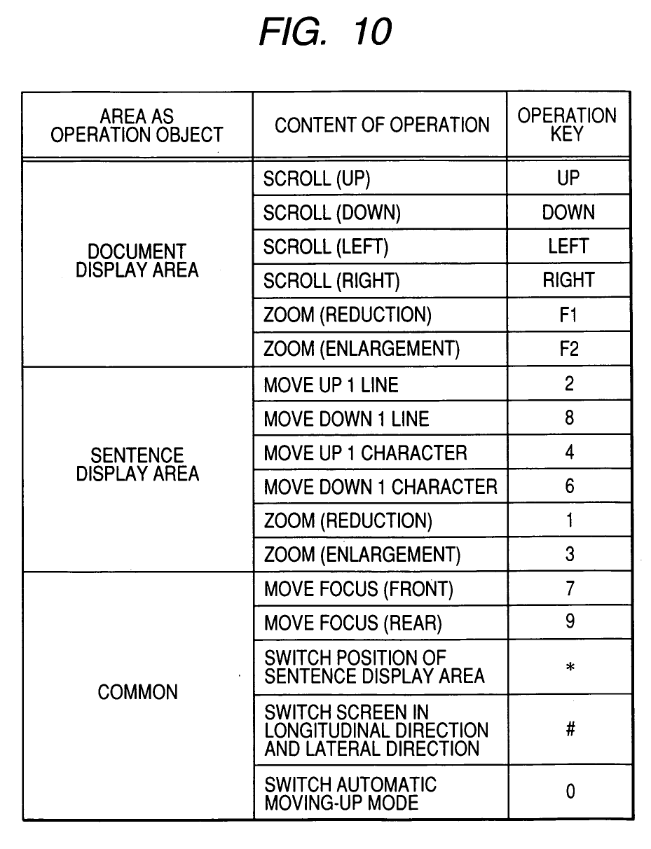

In the various operations after the sentence display mode is initiated, as shown in FIG. 10, the first function key 26, the second function key 28, the up direction key 30, the down direction key 32, the left direction key 34, the right direction key 36, and also the ten-numeral keys 38 are employed which are provided in the operation section 6.

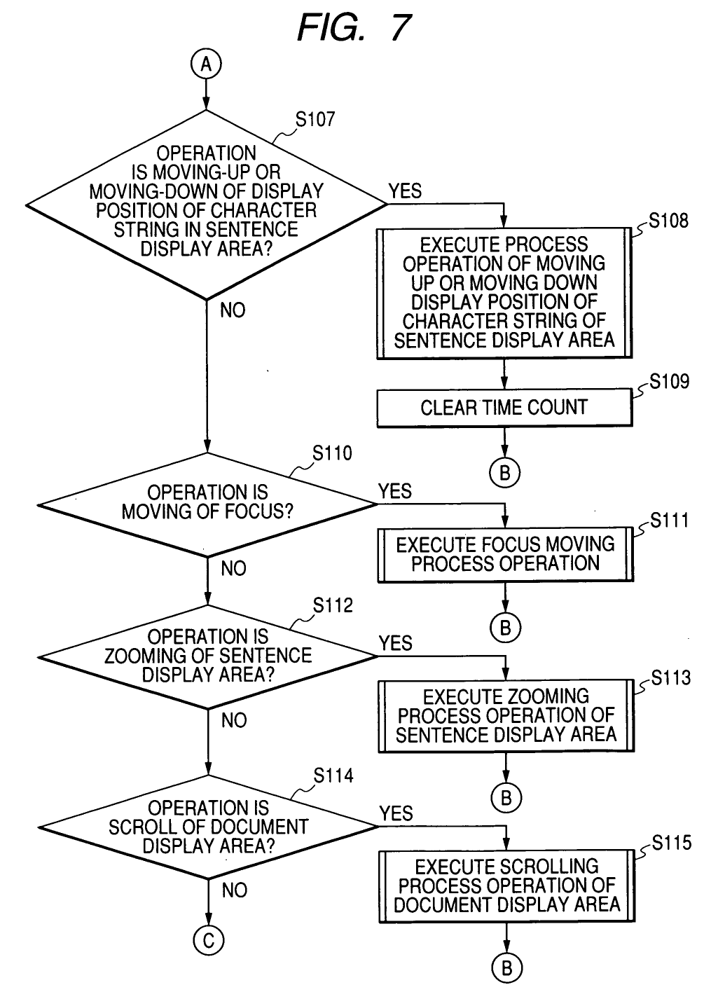

When any one of the operations is performed by the operation section 6 after the sentence display mode is initiated (“YES”) in step S101 of FIG. 6), the control section 16 executes various judging operations in respective steps S107, S110, S112, S114, S116, S118, S120, and S122 in FIG. 7 to FIG. 9. That is, the control section 16 judges whether or not a content of this operation corresponds to: moving-up or moving-down of a display position of a character string in the sentence display area 24; a move of the frame 42 (focus); zooming (enlarging) of the sentence display area 24; scroll (moving-up or moving-down of a display line) of the document display area 22; zooming (enlarging) of the document display area 22; switching of the sentence display area 24; switching of the longitudinal direction and the lateral direction of the display screen 18; or switching of an automatic scroll mode.

In a case where the operation executed in step S101 of FIG. 6 corresponds to either the moving-up operation or the moving-down operation of the display position of the character string in the sentence display area 24 (“YES” of step S101, and “YES” of step S107 of FIG. 7), the control section 16 judges whether or not any one of the numeral keys “2”, “8”, “4”, “6” of the ten-numeral keys 38 (refer to FIG. 2 and FIG. 10) is pressed in this operation, and then, performs either a moving-up process or a moving-down process of the display position of the character string displayed on the sentence display area 24 (step S108 of FIG. 7).

On the other hand, in the portable telephone 2, in addition to the up direction key 30, the down direction key 32, the left direction key 34 and the right direction key 36 which respectively function as first direction keys, the respective numeral keys “2”, “8”, “4”, “6” of the ten-numeral keys 38 respectively function as “up”, “down”, “left” and “right” as second direction keys. Under the operation of a program in which the second direction keys are valid, for example, in the document display mode, the control section 16 may also recognize these key inputs of the ten-numeral keys 38 as “up”, “down”, “left”, and “right.” Similarly, the numeral keys “9” and “7” of the ten-numeral keys 38 respectively function as “front” and “rear”.

For instance, in a case where the operation executed in the step S101 corresponds to a pressing of the numeral key “8” of the ten-numeral keys 38, the control section 16 deletes a first line of the character string being displayed on the sentence display area 24 shown in FIG. 5, and sequentially moves up a display position of each line of the character string which is located on a down stream side of the first line so as to be displayed on the sentence display area 24. Then, a character string which is equivalent to a number of characters included in one line of the sentence display area 24 is added as a new line to be continued to a last line in the sentence display area 24. The character string is extracted sequentially from a character subsequent to the character string surrounded by the frame 42 in the document 40 being displayed on the document display area 22. Then, the added character string is displayed.

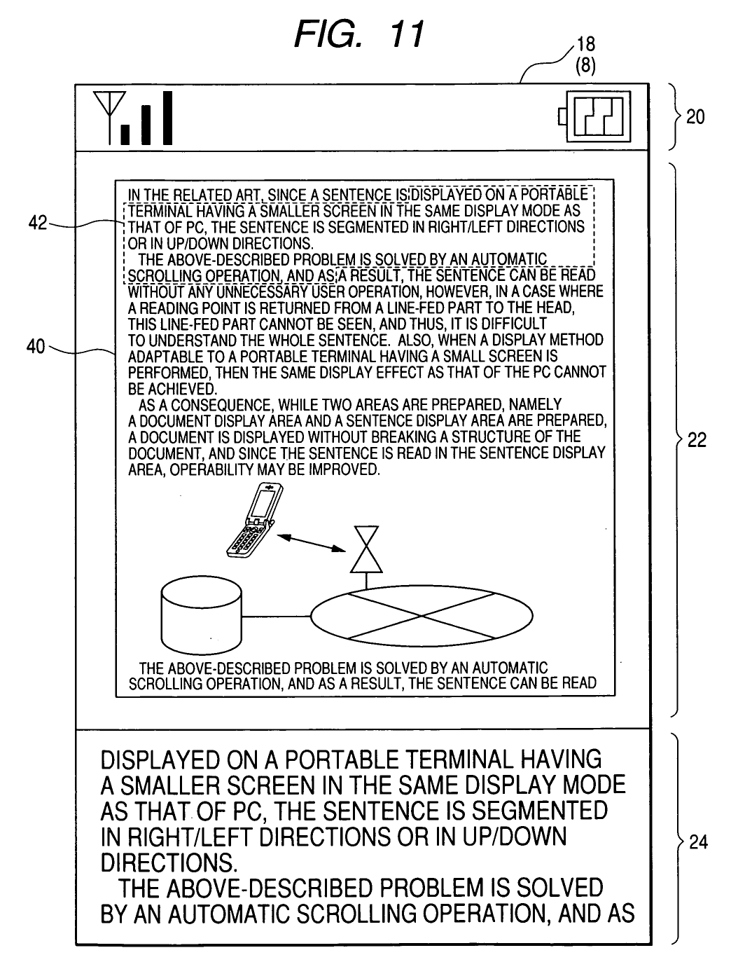

Also, in a step S108 of FIG. 7, when a process operation is performed that the character string in the sentence display area 24 is moved up in the up direction, the control section 16 moves the range of the character string surrounded by the frame 42 within the document 40 of the document display area 22, in the same step S108 as shown in FIG. 11. Then, the frame 42 surrounds the character string corresponding to the character string being displayed on the sentence display area 24.

Also, in a case where the operation executed in the step S101 of FIG. 6 corresponds to, for example, a pressing of the numeral key “6” of the ten-numeral keys 38, in the step S108 of FIG. 7, every time the numeral key “6” of the ten-numeral keys 38 is pressed, the control section 16 deletes a character at the head of the character string in the sentence display area 24 shown in FIG. 5. Then, the control section 16 sequentially moves up the display positions of the characters in the character string which are located on the down stream side of the character at the head of the character string sequentially for every one character to the left side within the sentence display area 24. Then, the control section 16 adds, as a new character, the next character of the character string which is surrounded by the frame 42 in the document 40 being displayed on the document display area 22, to be continued to an end of the character string in the sentence display area 24. Consequently, the control section 16 displays the newly-added character string.

Also, in the step S108 of FIG. 7, when the scroll process operation is performed in which the display position of the character string in the sentence display area 24 is moved up one character by one character, although not shown in the drawing, the control section 16 moves the range of the character string which are surrounded by the frame 42 within the document 40 of the document display area 22, in the same step S108. Then, the frame 42 surrounds the character string corresponding to the character string being displayed on the sentence display area 24.

Also, when the process operation executed in the step S108 of FIG. 7 is completed, a time count (will be explained later) is cleared in a step S109 of FIG. 7 in order to maintain a matching characteristic with a process operation of a step S106 of FIG. 6 (will be explained later).

Next, in a case where the operation executed in the step S101 of FIG. 6 corresponds to the operation for moving the frame 42 (focus) of the document display area 22 (“YES” of step S101, “NO” of step S107, and “YES” of step S110), the control section 16 judges whether or not this move operation corresponds to a pressing of the numeral key “7” or “9” (refer to FIG. 2 and FIG. 10) of the ten-numeral keys 38, and executes a process operation by which the range of the character string surrounded by the frame 42 within the document 40 of the document display area 22 is moved (step S111 of FIG. 7).

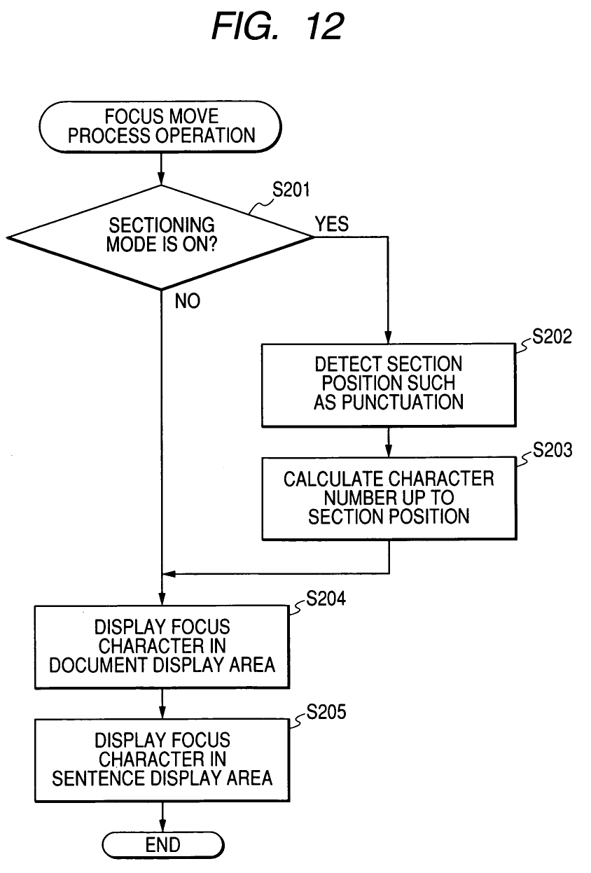

This process operation in the step S111 is executed by the control section 16 based upon a flow chart showing a subroutine shown in FIG. 12. In the subroutine, the control section 16 firstly judges whether or not a section mode is set to “ON” (step S201).

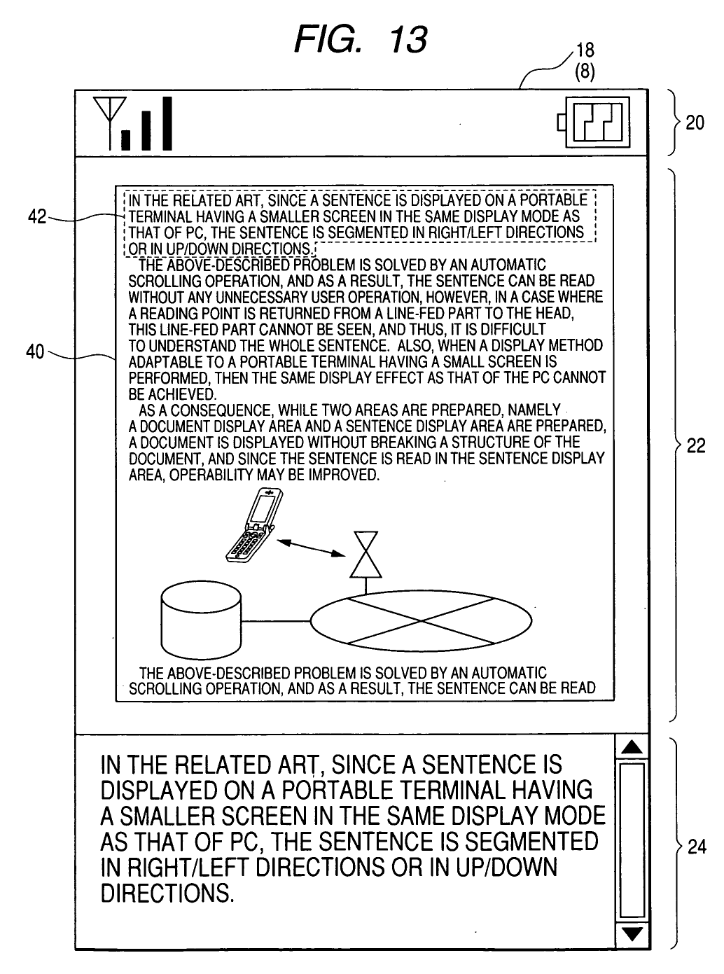

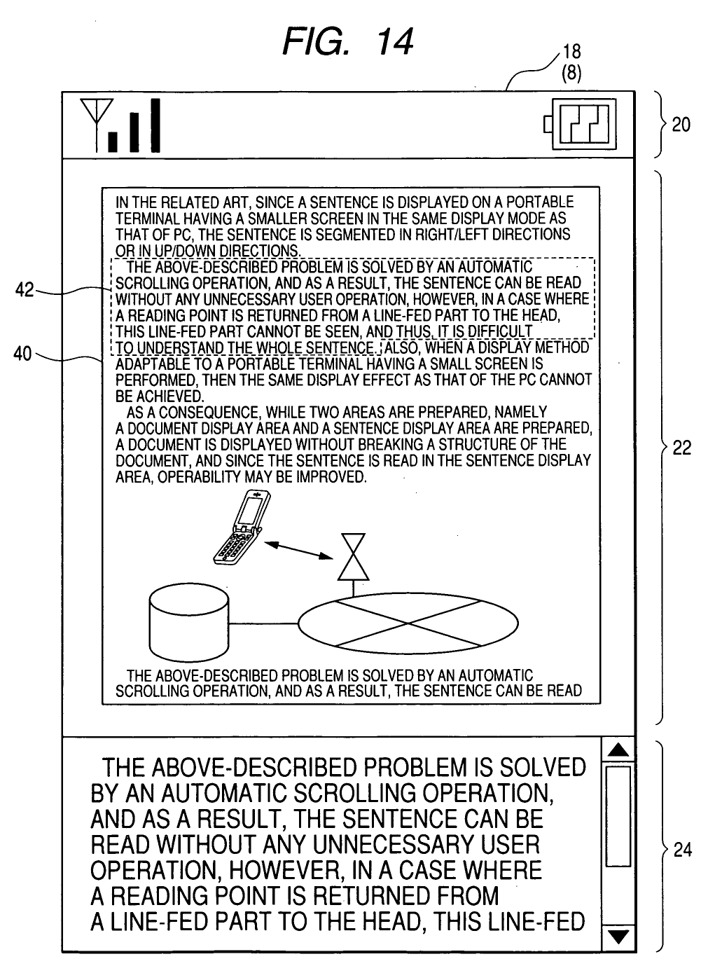

Here, the section mode is previously set by way of an operation before the sentence display mode is initiated in which the sentence display area 24 displays therein the character string of a part of the document 40 in the document display area 22. In a case where this section mode is set to “OFF”, after the sentence display mode is initiated, a maximum number of characters are displayed on the sentence display area 24, that is the maximum displayable character number in this sentence display area 24 (refer to FIG. 5). Also, in a case where this section mode is set to “ON”, after the sentence display mode is initiated similarly, only one sentence surrounded by, for example, a punctuation is displayed on the sentence display area 24, irrespective of the number of the characters (refer to FIG. 13 and FIG. 14).

When the section mode is set to “OFF” (“NO” in step S201) in the step S201 of FIG. 12, the control section 16 moves the range of the character string surrounded by the frame 42 within the document 40 of the document display area 22 shown in FIG. 5 based upon a total number of the pressing operations of the numeral key “9” or the numeral key “7” of the ten-numeral keys 38 which are executed in the step S101 of FIG. 6. The control section 16 moves the range of the character string to either a front (down stream) side or a rear (up stream) side for a number of characters that corresponds to the total number of the pressing operations (step S204 of FIG. 12). Also, the control section 16 extracts the character string corresponding to the character string which is surrounded by the frame 42 after being moved in the document 40 of the document display area 22, and displays this extracted character string on the sentence display area 24 (step S205).

When the section mode is set to “ON” (“YES” in step S201) in the step S201 of FIG. 12, the control section 16 reads the character code of the punctuation which is located subsequent to an end of the characters of the document 40 in the document display area 22, which are presently displayed on the sentence display area 24 (step S202). Thus, the control section 16 calculates a number of characters contained in one sentence which is subsequent to one sentence which is surrounded by the frame 42 at this time within the document 40 as shown in FIG. 13 (step S203 of FIG. 12).

Then, as shown in FIG. 14, the control section 16 moves the frame 42 so as to surround the character string of this subsequent one sentence (step S204 of FIG. 12). Also, the control section 16 displays only a number of characters within the sentence display area 24, which can be displayed within this sentence display area 24 among the character string which are newly surrounded by the frame 42 (step S205).

Although the character string which can not be displayed within the sentence display area 24 is not shown, that character string may be displayed by sequentially moving up the character string being displayed on the sentence display area 24 in the up direction.

Next, in a case where the operation executed in the step S101 of FIG. 6 corresponds to the zooming operation of the sentence display area 24 (“YES” of step S101, “NO” of step S107, “NO” of step 110, and “YES” of step S112 shown in FIG. 7), the control section 16 judges whether or not this operation corresponds to a pressing of the numeral key “1” or “3” (see FIG. 2 and FIG. 10) of the 10-numeral entry key 38. Then, the control section 16 changes the size of the characters displayed on the sentence display area 24 (step S113 of FIG. 7). As a consequence, the number of the characters of the character string which can be displayed on the sentence display area 24 is increased/decreased based upon the changed size of the characters by this zooming process operation.

Also, when the operation executed in the step S101 of FIG. 6 corresponds to the scrolling operation of the document display area 22 (“YES” of step S101, “NO” of step S107, “NO” of step S110, “NO” of step S112, and “YES” of step S114 shown in FIG. 7), the control section 16 judges whether or not this operation corresponds to a pressing of any one of the up direction key 30, the down direction key 32, the left direction key 34, and the right direction key 36 (refer to FIG. 2 and FIG. 10) of the operation section 6. Then, the control section 16 scrolls the document 40 in the document display area 22 in any one of the up direction, the down direction, the left direction, and the right direction (step S115 of FIG. 7).

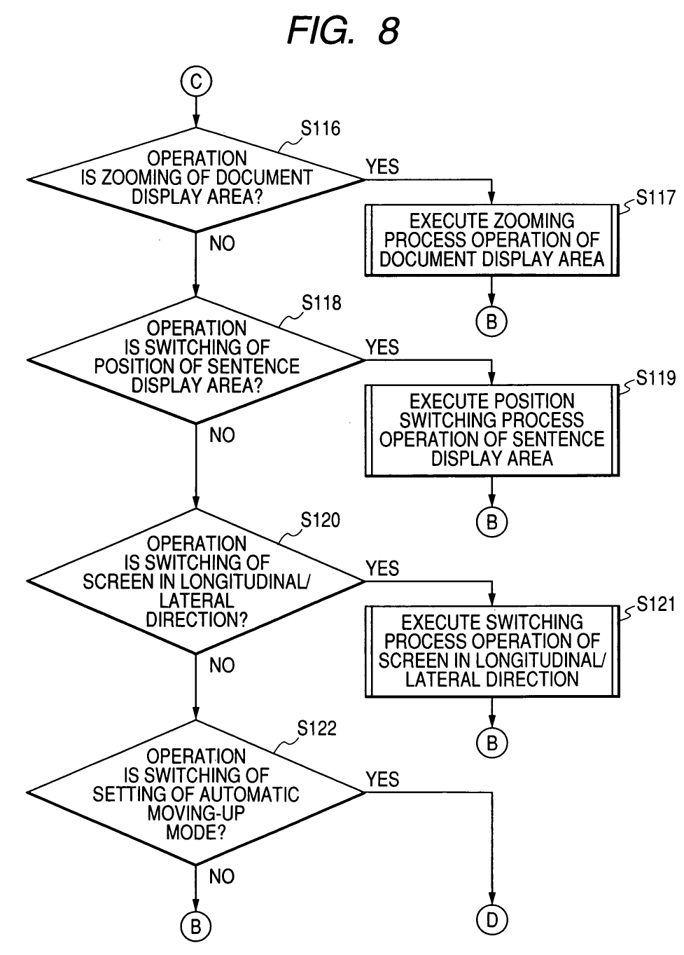

Also, in a case where the operation executed in the step S101 of FIG. 6 corresponds to the zooming operation of the document display area 22 (“YES” of step S101, “NO” of step S107, “NO” of step S110, “NO” of step S112, “NO” of step S114, and “YES” of step S116 shown in FIG. 8), the control section 16 judges whether or not this operation corresponds to a pressing of any one of the first function key 26 and the second function key 28 (refer to FIG. 2 and FIG. 10) of the operation section 6. Then, the control section 16 displays the document 40 on the document display area 22 in a reduced size or an enlarged size (step S117 of FIG. 8).

Also, in a case where the operation performed in the step S101 of FIG. 6 corresponds to the switching operation for switching the display position of the sentence display area 24 where the “*” key (see FIG. 2 and FIG. 10) of the ten-numeral keys 38 is pressed (“YES” of step S101, “NO” of step S107, “NO” of step S110, “NO” of step S112, and “NO” of step S114 shown in FIG. 7, “NO” of step S116, and “YES” of step S118 shown in FIG. 8), the control section 16 displays both the document display area 22 and the sentence display area 24 by replacing the up/down positional relationship with each other (step S119 of FIG. 8).

Also, in a case where the operation performed in the step S101 of FIG. 6 corresponds to the switching operation for switching the display screen 18 in the longitudinal direction and the lateral direction where the key “#” (see FIG. 2 and FIG. 10) of the 10-numeral entry key 38 is pressed (“YES” of step S101, “NO” of step S107, “NO” of step S110, “NO” of step S112, and “NO” of step S114 shown in FIG. 7, “NO” of step S116, “NO” of step S118, and “YES” of step S120 shown in FIG. 8), the control section 16 divides the region of the display screen 18 (see FIG. 2) except for the pictorial area 20 into two regions which are arranged in the width direction of the display screen 18, although not shown. Then, one of the newly divided regions is displayed as the document display area, and the other one of the newly divided regions is displayed as the sentence display area (step S121 of FIG. 8).

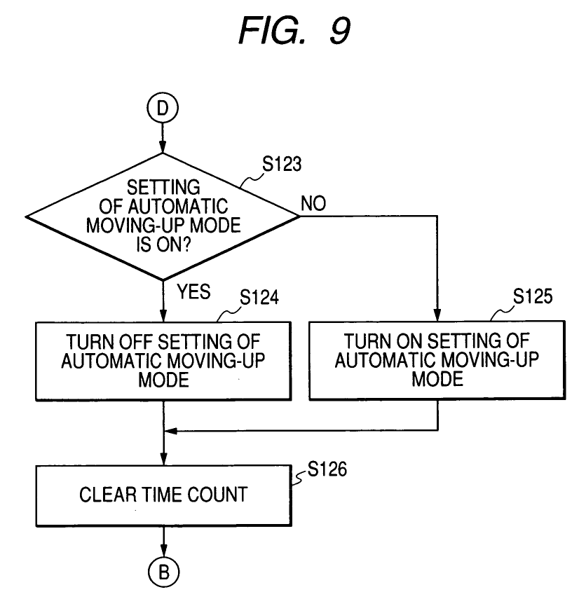

Also, in a case where the operation performed in the step S101 of FIG. 6 corresponds to the switching operation for switching the setting of the automatic scroll mode where the numeral key “0” (see FIG. 2 and FIG. 10) of the ten-numeral keys 38 is pressed (“YES” of step S101, “NO” of step S107, “NO” of step S110, “NO” of step S112, and “NO” of step S114 shown in FIG. 7, “NO” of step S116, “NO” of step S118, “NO” of step S120, and “YES” of step S122 shown in FIG. 8), the control section 16 executes the process operations from a step S123 to a step S126 of FIG. 9.

In other words, when the numeral key “0” of the ten-numeral keys 38 is pressed in the step S101 of FIG. 6, in a case where the automatic scroll mode is set to “ON” (“YES” of step S123 of FIG. 9), the control section 16 switches the setting state of the automatic scroll mode to the “OFF” state (step S124), and then, clears the time count which will be explained later (step S126).

Also, when the numeral key “0” of the ten-numeral keys 38 is pressed in the step S101 of FIG. 6, in a case where the automatic scroll mode is set to “OFF” (“NO” of step S123 of FIG. 9), the control section 16 switches the setting state of the automatic scroll mode to the “ON” state (step S125), and then, clears the time count which will be explained later (step S126).

Next, a description is made of the process operations executed by the control section 16 in a case where no operation is performed for a predetermined time after the sentence display mode is initiated.

When, no operation is performed after the sentence display mode is initiated (“NO” in step S101 of FIG. 6), the control section 16 judges whether or not the automatic scroll mode is set to the “ON” state (step S102).

In a case where the automatic scroll mode is set to the “ON” state (“YES” of step S102), the control section 16 starts a time measuring operation by a timer (not shown) employed in this control section 16 (step S103). Also, the control section 16 counts up the time count in a case where after the control section 16 executed the process operations from the step S101 to this step S103 and “NO” of the next step S104 in a loop manner, and the process operation is again returned to this step S103.

Then, in the next step S104, when the control section 16 judges that a predetermined time is passed after the time measuring operation is started (“YES” in step S104), the control section 16 sequentially moves up the respective lines of the character string in the sentence display area 24 by one line (step S105 of FIG. 6) in the up direction, similarly to when the control section 16 sequentially moves up the respective lines of the character string in the sentence display area 24 in the up direction in the step S108 of FIG. 7. Then, the control section 16 clears the time count being measured (step S106), and thereafter, the process operation is returned to a step just before the step S101.

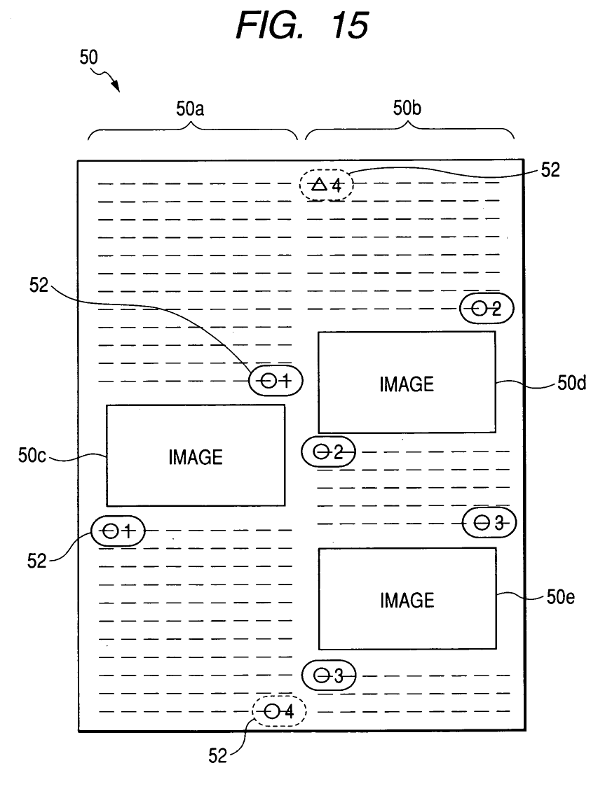

Next, a description is made of process operations executed by the control section 16 in a case where a document 50 shown in FIG. 15 is displayed on the document display region 22 of the display screen 18 shown in FIG. 2.

In the document 50 shown in FIG. 15, sentences are written in the lateral direction over a substantially entire region thereof. This entire region is divided into two description regions 50a and 50b which are arranged in the lateral direction. In the sentences respectively described in these description regions 50a and 50b, line feeds are inserted within the description regions 50a and 50b. Then, in this document 50, an image 50c is arranged between lines of the sentences in the description region 50a, whereas both an image 50d and an image 50e are arranged between lines of the sentences in the description region 50b.

In a case where this document 50 is displayed on the document display area 22, in the beginning, the control section 16 cannot make a judgment as to this document 50. For instance, the control section 16 cannot judge whether an end of a line just before the image 50c of the document written in the description region 50a connects to a head of a line just after the image 50c, or connects to a head of a first line of the sentences written in the description region 50b.

When this document 50 is displayed on the document display area 22, in the beginning, the control section 16 cannot judge whether an end of a last line of the sentences written in the description region 50a connects to a head of a first line of the sentences written in the description region 50b, or connects to a head of a line just after the image 50e.

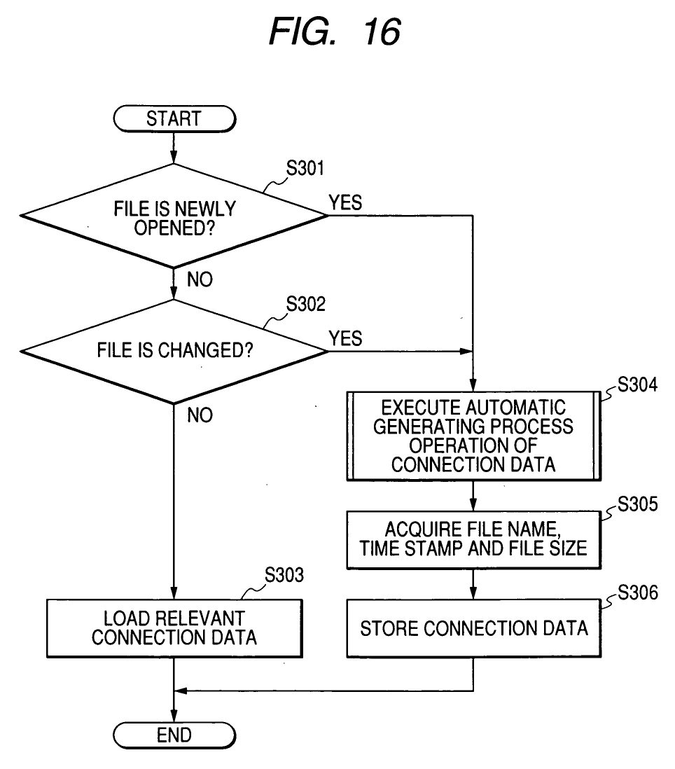

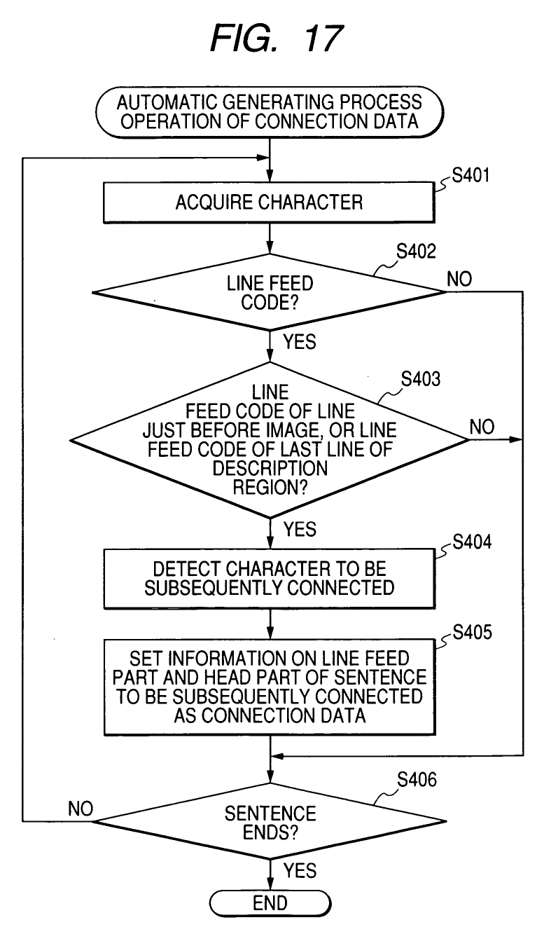

Due to the above-explained reasons, the control section 16 performs preliminary judging operations, and thus, generates connection data 52 based upon this preliminary judging operations in accordance with process operations of flow charts shown in FIG. 16 and FIG. 17. That is, in the preliminary judging operations, ends of paragraphs just before the images 50c, 50d, 50e connect to heads of paragraphs just after these images 50c, 50d, 50e. Also, an end of a last line of the description region 50a connects to a head of a first line of the description region 50b, the description region 50b being located in an extended direction on the end side in a written direction (lateral direction) of the last line of this description region 50a.

In the normal operation, this connection data 52 is not displayed in the document 50. However, when a predetermined operation is performed, as shown in FIG. 15, the connection data 52 may be alternatively displayed at a corresponding position within the document 50. Then, this connection data 52 may be corrected, deleted, or added by performing the operation.

Also, in a case where while the document 50 is displayed on the document display area 22 shown in FIG. 2, and a character string corresponding to the character string of a part in the document 50 is displayed on the sentence display area 24, when the connection data 52 is included in the character string of the part in the document 50, the control section 16 makes an order of the character string to be displayed on the sentence display area 24 correspond to the connection data 52.

Furthermore, for example, there is not only the case where the end of the paragraph just before the image 50c continues to the head of the paragraph just after the image 50c, but also another case where the end of the paragraph just before the image 50c continues to the head of the description region 50b. As a consequence, the control section 16 may display the connection data 52, and then, may perform the control operation in such a manner that the user selects which case is correct in view of a connection.

Subsequently, a description is made of process operations executed by the control section 16 when the connection data 52 of the document 50 is generated, etc., with reference to flow charts shown in FIG. 16 and FIG. 17.

After the document 50 is displayed on the display screen 18 by performing the operation, when the sentence display mode is initiated in which the character string of the part of this document 50 is displayed on the sentence display area 24, the control section 16 judges whether or not this document 50 is newly displayed on the sentence display mode (whether or not this document 50 is a data file to be opened for the first time) by checking whether or not the connection data 52 corresponding to this document 50 is stored in the storage section 14 shown in FIG. 1 (step S301 of FIG. 16).

Then, when the control section 16 judges that this document 50 is not newly displayed in the sentence display mode (“NO” in step S301), the control section 16 compares the document 50 with the connection data 52 stored in the storage section 14 in order to judge whether or not data content of the document 50 is changed (step S302).

In a case where the control section 16 judges that the data content of the document 50 is not changed (“NO” in step S302), the control section 16 employs the connection data 52 corresponding to this document 50, which is stored in the storage section 14 (step S303).

Also, in a case where the control section 16 judges in the step S301 that the document 50 is newly displayed in the sentence display mode (“YES” of step S301), or in a case where the control section 16 judges in the step S302 that the data content in the document 50 is changed (“YES” in step S302), the control section 16 generates connection data 52 of this document 50 (step S304). Then, the control section 16 adds a file name, a time stamp, a file size and the like to a plurality of the connection data 52 which is generated for the document 50 as integrated data (step S305). Thereafter, the control section 16 stores the resultant connection data 52 in the storage section 14 (step S306).

Also, the connection data 52 in the step S304 is generated in accordance with the flow chart of the subroutine shown in FIG. 17. The control section 16 executes the process operations of this subroutine with respect to all of the characters in the document 50. In a step S401, the control section 16 judges whether or not a character obtained as an object to which the process operation of this subroutine is performed corresponds to a line feed code (end of line) (step S402).

In a case where this character corresponds to the line feed code (“YES” of step S402), the control section 16 judges whether or not this line feed code is a code which is written in, for example, a line just before the image 50c as shown in FIG. 15, and also, judges whether or not this line feed code is a code which is written in a last line of the description region 50a (step S403 of FIG. 17).

When this line feed code is the code which is written in, for example, the line just before the image 50c (“YES” of step S403), the control section 16 detects a character at a head of the line just after the image 50c (step S404), and defines a combination of the line feed code of the line just before the image 50c and the character at the head of the line just after this image 50c as the connection data 52 (step S405).

Also, in the step S403, when the line feed code is a code which is written in the last line within the description region 50a (“YES” of step S403), the control section 16 detects a character at a head of a first line of the description region 50b (step S404), and defines a combination of the line feed code of the last line in the description region 50a and the character at the head of the first line in the description region 50b as the connection data 52 (step S405).

Then, when the control section 16 completes the process operations up to the step S405, the control section 16 confirms whether or not the character as the object of the process operations up to this step S405 corresponds to the last character of the document 50 (step S406). In a case where the control section 16 judges that this subject character is not the last character (“NO” of step S406), the control section 16 repeatedly executes the process operations from the step S401 as to a next character.

Further, in a case where the character as the object of the process operation is not the line feed code in the step S402 (“NO” in step S402), and also, in a case where the line feed code is not a code which is written in the line just before the image 50c, and not a code which is written in the last line within the description region 50a in the step S403 (“NO” in step S403), the control section 16 performs a process operation similarly to when the process operation up to the step S405 is completed. Namely, the control section 16 confirms whether or not the character as the object of the process operations corresponds to the last character of the document 50 (step S406). In a case where the control section 16 judges that this character is not the last character (“NO” of step S406), the control section 16 repeatedly executes the process operations from the step S401 as to a next character.

As previously explained, in accordance with the portable telephone 2 and the document display control method thereof related to this embodiment, while the document 40 is displayed on the document display area 22 on the display screen 18 of the display section 8 of this portable telephone 2, in a case where the character string of the part of the document 40 displayed on this document display area 22 is displayed on the sentence display area 24, the scrolling operation in which the reading operation goes and returns between the head side and the end side of each of the lines is no longer required in order to read the character string displayed on this sentence display area 24.

Also, even in a case where the document 50 as shown in FIG. 15 is displayed on the document display area 22, and the character string of the part of this document 50 shown in the document display area 22 is displayed on the sentence display area 24, the scrolling operation in which the reading operation goes and returns between the head side and the end side of each of these lines is no longer required in order to read the character string displayed on this sentence display area 24. In the document 50 of FIG. 15, the entire region of this document 50 is divided into two description regions 50a and 50b, and the images 50c, 50d, 50e are arranged between the paragraphs in the sentences within the description regions 50a and 50b.

When a character string is simply displayed in an enlarge size, in a case where a document which is at first written by using a small font, as the document directed to the personal computer, the character font may be deteriorated, which is hardly read. However, in accordance with the present invention, the character string is once extracted as the character codes, and thereafter, the character string is displayed in the proper size on the sentence display area. Since the display is not the simple enlargement/reduction, this character string can be displayed with a font that is easily readable.

It should also be noted that although the above-explained embodiment is described in a case where the present invention is applied to the portable telephone 2, the present invention may be apparently applied to a portable terminal other than the portable telephone 2, for instance, PHS (Personal Handy phone System), PDA (Personal Digital Assistant), a car navigation system and the like.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A portable terminal comprising:
a display section; and
a control section for dividing at least a part of a display region of the display section into a first display region and a second display region, making the display section to display a document on the first display region, extracting a character string from the document displayed on the first display region, and making the display section to display the extracted character string on the second display region.

2. The portable terminal as claimed in claim 1, wherein the control section makes the display section to display the character string on the second display region in a different font from that of the document displayed on the first display region.

3. The portable terminal as claimed in claim 1, wherein the control section makes the display section to display an extracted part of the document on the first display region in a different mode from that of other part of the document, the extracted part of the document corresponding to the extracted character string or the character string to be extracted.

4. The portable terminal as claimed in claim 1, wherein in a case where an operation for displaying a subsequent character on the second display region is performed, the subsequent character being subsequent to the displayed character string on the second display region, the control section performs:
deleting a first character of a head of the character string;
sequentially moving up a display position of respective characters which follow after the first character so as to move up the character string;
extracting the subsequent character that is subsequent to an extracted part of the document corresponding to the character string being displayed on the second display region; and
adding the extracted character to an end of the moved-up character string so as to be displayed on the second display region.

5. The portable terminal as claimed in claim 1, wherein the second display region displays the character string in a plurality of lines by inserting a line feed in the character string for every predetermined number of characters, and
in a case where an operation for displaying a subsequent line on the second display region is performed, the subsequent line being subsequent to a final line of the character string displayed on the second display region, the control section performs:
deleting a first line at a head line of the character string;
sequentially moving up a display position of respective lines of the character string which follow after the first line so as to move up the character string;
extracting the predetermined number of characters as the subsequent line which is subsequent to an extracted part of the document corresponding to the character string being displayed on the second display region; and
adding the extracted characters as a new line to the final line of the moved-up character string so as to be displayed on the second display region.

6. The portable terminal as claimed in claim 1, wherein in a case where an operation for switching display regions is performed, the control section performs switching the first display region and the second display region.

7. The portable terminal as claimed in claim 1, further comprising:
a communication section for acquiring the document via a network,
wherein the document is generated not only to be used in the portable terminal.

8. The portable terminal as claimed in claim 1, further comprising:
an operation section for operating to the control section to make display in the display section change.

9. The portable terminal as claimed in claim 8, wherein the operation section includes a plurality of key groups, and
each of the key groups can operate to the control section to make at least one of display in the first display region and display in the second display region change.

10. The portable terminal as claimed in claim 9, wherein one of the key groups includes direction keys.

11. The portable terminal as claimed in claim 10, wherein another one of the key groups includes numeral keys arranged in a matrix.

12. A document display control method used in a portable terminal having a display section, comprising:
dividing at least a part of a display region of the display section into a first display region and a second display region;
displaying a document on the first display region;
extracting a character string from the document displayed on the first display region; and
displaying the extracted character string on the second display region.

13. The document display control method as claimed in claim 12, comprising:
displaying the character string on the second display region in a different font from that of the document displayed on the first region.

14. The document display control method as claimed in claim 12, comprising:
displaying an extracted part of the document on the first display region in a different mode from that of other part of the document, the extracted part of the document corresponding to the extracted character string or the character string to be extracted.

15. The document display control method as claimed in claim 12, comprising:
deleting a first character of a head of the character string;
sequentially moving up a display position of respective characters which follow after the first character so as to move up the character string;
extracting a subsequent character that is subsequent to an extracted part of the document corresponding to the character string being displayed on the second display region; and
adding the extracted character to an end of the moved-up character string so as to be displayed on the second display region.

16. The document display control method as claimed in claim 12, wherein the second display region displays the character string in a plurality of lines by inserting a line feed in the character string for every predetermined number of characters,
the document display control method comprising:
deleting a first line at a head line of the character string;
sequentially moving up a display position of respective lines of the character string which follow after the first line so as to move up the character string;
extracting the predetermined number of characters as a subsequent line which is subsequent to an extracted part of the document corresponding to the character string being displayed on the second display region; and
adding the extracted characters as a new line to the final line of the moved-up character string so as to be displayed on the second display region.

17. The document display control method as claimed in claim 12, comprising:
switching the first display region and the second display region when an operation for switching display regions is performed.

18. The document display control method as claimed in claim 12, comprising:
performing communication for acquiring the document via a network,
wherein the document is generated not only to be used in the portable terminal.

19. The document display control method as claimed in claim 12, wherein the portable terminal has a plurality of key groups,
the document display control method comprising:
changing at least one of display in the first display region and display in the second display region based on an operation of each of the key groups.
